(19) United States
(12) Patent Application Publication
(10) Pub. No.: US 2013/0000812 A1
(43) Pub. Date: Jan. 3, 2013

(54) LAMINATED FOIL MANUFACTURING APPARATUS AND LAMINATED FOIL MANUFACTURING METHOD

(75) Inventors: Kiyohiko TAKEMOTO, Matsumoto-shi (JP); Kazuaki TSUKIANA, Azumino-shi (JP); Masakazu OHASHI, Shioziri-shi (JP)

(73) Assignee: SEIKO EPSON CORPORATION, Tokyo (JP)

(21) Appl. No.: 13/529,283

(22) Filed: Jun. 21, 2012

(30) Foreign Application Priority Data
Jun. 28, 2011 (JP) 2011-142605

(51) Int. Cl. B32B 37/12

(52) U.S. Cl. 156/60; 156/556

(57) ABSTRACT

A laminated foil manufacturing apparatus includes a transportation unit that transports a lamination target medium onto which foil is to be laminated with intermittent movement and continuous movement, a liquid adhering unit that performs adhering processing of making liquid adhere to the lamination target medium which is transported with the intermittent movement by the transportation unit, and a foil laminating unit that is arranged at a downstream side with respect to a position of the liquid adhering unit in a transportation direction of the lamination target medium which is transported with the intermittent movement, and performs foil laminating processing of laminating the foil onto a surface to which the liquid has been adhered on the lamination target medium which is transported with the continuous movement by the transportation unit after the adhering processing has been performed.

### BACKGROUND

1. Technical Field

The present invention relates to a laminated foil manufacturing apparatus and a laminated foil manufacturing method.

2. Related Art

In an existing printed material obtained by printing an image on a film such as a transfer film, a laminating film, a packing film, or a label film, a print image is decorated in the following manner in order to enhance a decorative effect of the print image. That is, for example, aluminum foil or the like having metallic luster is laminated onto a film of a base material so as to form laminated foil. In recent years, a laminated foil manufacturing apparatus having a configuration which makes it possible to perform on-demand printing by using no printing plate has been proposed as an apparatus for manufacturing such laminated foil in a small lot at low cost.

For example, an on-demand foil transfer printing apparatus has been disclosed in JP-A-2009-226863 as a laminated foil manufacturing apparatus. The on-demand foil transfer printing apparatus includes a configuration which makes it possible to transfer (laminate) multicolored foil and perform printing on the foil by using ink jet recording in which liquid is discharged (ejected) to form an image. That is to say, predetermined liquid is discharged in an image forming manner from a liquid droplet delivery head onto either of a lamination target medium (recording target medium) onto which foil is to be laminated or foil, active energy rays are irradiated onto the discharged liquid, and then, an image of a pressure-sensitive adhesive having adhesiveness is formed on either of the lamination target medium or the foil. Then, the formed image of the adhesive is transferred onto either of the lamination target medium or the foil with pressure by a nip roller so as to form an image of foil on the lamination target medium. Thereafter, ink containing at least colorant is discharged from an ink jet head so as to form an image on the lamination target medium on which the image of the foil has been formed.

In the laminated foil manufacturing apparatus as disclosed in JP-A-2009-226863, any of the liquid droplet delivery head and the ink jet head are configured by so-called line heads on which a plurality of nozzles are arranged in a direction intersecting with a transportation direction of the lamination target medium. That is to say, in the laminated foil manufacturing apparatus as disclosed in JP-A-2009-226863, ink jet recording using the line heads which form an image by landing liquid on the transported lamination target medium on a single path is performed.

However, nozzles are required to be arranged on the line head over an entire range in the width direction intersecting with the transportation direction of the lamination target medium as is well known. Therefore, the head is increased in cost, and an apparatus is increased in cost eventually. Further, the number of line heads corresponding to types of liquids to be landed are required to be provided. This arises a problem in that an apparatus is increased in size. Accordingly, a laminated foil manufacturing apparatus which makes it possible to suppress the apparatus from being increased in size by using a method of ink jet recording of serial scanning in which liquid is ejected (landed) on a plurality of paths, and laminates foil onto a lamination target medium stably has been desired.

### SUMMARY

An advantage of some aspects of the invention is to provide a laminated foil manufacturing apparatus and a laminated foil manufacturing method which make it possible to suppress the apparatus from being increased in size, and laminate foil onto a lamination target medium stably.

A laminated foil manufacturing apparatus according to an aspect of the invention includes a transportation unit that transports a lamination target medium onto which foil is to be laminated with intermittent movement and continuous movement, a liquid adhering unit that performs adhering processing of making liquid adhere to the lamination target medium which is transported with the intermittent movement by the transportation unit, and a foil laminating unit that is arranged at a downstream side with respect to a position of the liquid adhering unit in a transportation direction of the lamination target medium which is transported with the intermittent movement, and performs foil laminating processing of laminating the foil onto a surface to which the liquid has been adhered on the lamination target medium which is transported with the continuous movement by the transportation unit after the adhering processing has been performed.

With this configuration, the lamination target medium is transported with the intermittent movement and the continuous movement. Therefore, an image can be formed on the lamination target medium by ink jet recording of serial scanning by ejecting liquid onto the lamination target medium in a stopped state during the transportation with the intermittent movement, for example. Accordingly, the apparatus can be suppressed from being increased in size. On the other hand, the foil is laminated onto the lamination target medium which is transported with the continuous movement so that the foil can be laminated onto the lamination target medium stably.

In the laminated foil manufacturing apparatus according to the aspect of the invention, it is preferable that the transportation unit transport the lamination target medium with the continuous movement in an opposite direction to a direction in which the lamination target medium is transported with the intermittent movement.

With this configuration, transportation with the intermittent movement and transportation with the continuous movement are not mixed in one transportation direction. Therefore, a transportation buffering mechanism which absorbs a difference in a transportation amount between the transportation with the intermittent movement and the transportation with the continuous movement is not required to be provided. Accordingly, the laminated foil manufacturing apparatus can be suppressed from being increased in size.

In the laminated foil manufacturing apparatus according to the aspect of the invention, it is preferable that the transportation unit transport the lamination target medium onto which the foil has been laminated by the foil laminating unit with the continuous movement to an upstream side with respect to a position of the liquid adhering unit in a transportation direction of the lamination target medium which is transported with the intermittent movement.

With this configuration, the lamination target medium onto which the foil has been laminated is transported with the intermittent movement, again. Therefore the liquid adhering unit can perform ink jet recording of serial scanning on the lamination target medium so as to make liquid adhere thereto, again. Accordingly, laminated foil can be manufactured efficiently. For example, overlapping recording can be performed.

In the laminated foil manufacturing apparatus according to the aspect of the invention, it is preferable that the laminated foil manufacturing apparatus include a liquid fixing unit that is arranged downstream side with respect to a position of the foil laminating unit in a transportation direction of the lamination target medium which is transported with the intermittent movement, and perform fixing processing of fixing the liquid adhered by the liquid adhering unit to the lamination target medium.

With this configuration, after the liquid fixing unit has performed first fixing processing of fixing the liquid adhered to the lamination target medium when the lamination target medium is transported with the intermittent movement, second fixing processing of fixing the adhered liquid can be performed on the lamination target medium which is transported with the continuous movement in the opposite direction to a direction in which the lamination target medium is transported with the intermittent movement. Accordingly, the liquid can be fixed stably.

In the laminated foil manufacturing apparatus according to the aspect of the invention, it is preferable that the transportation unit include a pair of transportation rollers that nip and transport the lamination target medium at a downstream side with respect to the liquid adhering unit in a transportation direction of the lamination target medium when the lamination target medium is transported with the continuous movement, and the foil laminating unit include a pair of rotary rollers that nip the lamination target medium and the foil and rotate about shafts extending in a width direction intersecting with a transportation direction of the lamination target medium which is transported with the continuous movement when the lamination target medium is transported with the continuous movement.

With this configuration, the lamination target medium is transported with the continuous movement by the transportation roller provided at the downstream side with respect to the liquid adhering unit. Therefore, the foil laminating processing can be performed on the lamination target medium while continuously rotating the pair of rotary rollers which nip the lamination target medium. Accordingly, in the foil laminating processing, a preferred configuration as the transportation unit which transports the lamination target medium with the continuous movement in the opposite direction to a direction in which the lamination target medium is transported with the intermittent movement can be obtained.

In the laminated foil manufacturing apparatus according to the aspect of the invention, it is preferable that the laminated foil manufacturing apparatus include a lamination target medium holding portion having a lamination target medium holding surface which holds the lamination target medium on a region on which the liquid adhering unit is arranged, and that the pair of rotary rollers provided in the foil laminating unit nip the lamination target medium which is transported with the continuous movement in a direction intersecting with the lamination target medium holding surface.

With this configuration, even if the lamination target medium is displaced with the displacement of the rotary roller in the foil laminating processing, an influence on displacement of the lamination target medium in a normal direction of the lamination target medium holding surface can be suppressed on the lamination target medium holding surface. Accordingly, the lamination target medium which is continuously transported and the liquid adhering unit are suppressed from making into contact with each other.

A laminated foil manufacturing method according to another aspect of the invention includes liquid adhering in which a lamination target medium onto which a foil is to be laminated is transported with intermittent movement, and adhering processing that is liquid adhering is performed on the lamination target medium which is transported with the intermittent movement, and foil laminating in which the lamination target medium which has been performed the adhering processing is transported with continuous movement, and the foil is laminated on the surface on which the liquid has been adhered on the lamination target medium which is transported with continuous movement.

With this method, in the transportation of the lamination target medium, after an image has been formed on the lamination target medium by performing ink jet recording of serial scanning on the lamination target medium which is transported with the intermittent movement, foil (for example, decorative foil) can be laminated onto the lamination target medium which is transported with the continuous movement. Accordingly, quality of an image which is formed on the lamination target medium onto which the foil has been laminated can be ensured.

### BRIEF DESCRIPTION OF THE DRAWINGS

The invention will be described with reference to the accompanying drawings, wherein like numbers reference like elements.

FIG. 1 is a view schematically illustrating an overall configuration of a laminated foil manufacturing apparatus according to an embodiment of the invention.

FIG. 2 is a flowchart illustrating a manufacturing process that is performed by the laminated foil manufacturing apparatus according to the embodiment.

FIGS. 3A to 3C are views for explaining processing contents in the process supplementarily, FIG. 3A is a view schematically illustrating a process A, FIG. 3B is a view schematically illustrating a process B, and FIG. 3C is a view schematically illustrating a process C.

FIG. 4 is a cross-sectional view illustrating a transfer film that is manufactured by the laminated foil manufacturing apparatus according to the embodiment.

FIG. 5 is a cross-sectional view illustrating another film that is manufactured by the laminated foil manufacturing apparatus according to the embodiment.

FIG. 6 is a view illustrating a schematic configuration of a laminated foil manufacturing apparatus according to a variation.

FIG. 7 is a view illustrating a schematic configuration of a laminated foil manufacturing apparatus according to another variation.

### DESCRIPTION OF EXEMPLARY EMBODIMENTS

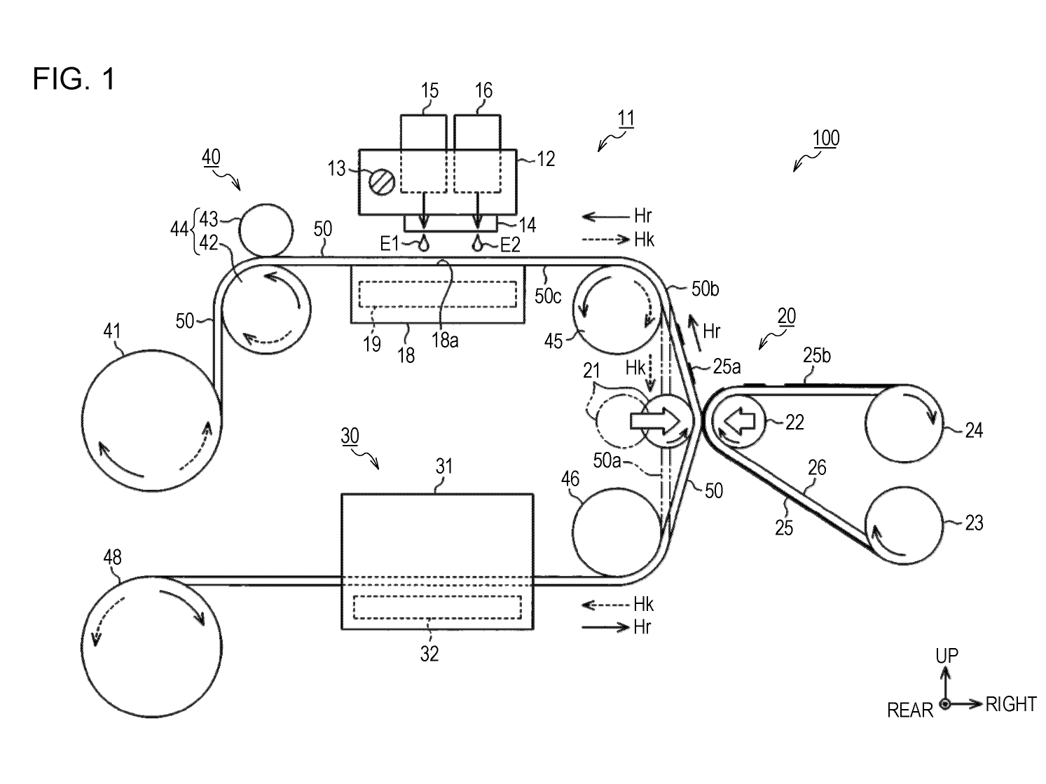

An embodiment of a laminated foil manufacturing apparatus to which the invention is embodied is described with reference to the drawings. In the following description, “front-rear direction”, “right-left direction”, and “up-down direction” indicate front-rear direction, right-left direction, and up-down direction which are indicated by arrows in the drawings, respectively. Note that in FIG. 1, the up-down direction corresponds to the vertical direction and the right-left direction corresponds to the horizontal direction intersecting with the up-down direction. Further, the front-rear direction is a direction intersecting with both of the up-down direction and the right-left direction and corresponds to the direction in which a carriage 12 reciprocates, that is, the scanning direction.

As illustrated in FIG. 1, a laminated foil manufacturing apparatus 100 includes a liquid adhering unit 11 and a foil laminating unit 20. The liquid adhering unit 11 performs adhering processing of ejecting liquid onto a print base material 50 as an example of a lamination target medium onto which foil is laminated so as to make the liquid adhere thereto. The foil laminating unit 20 performs foil laminating processing of transferring the foil to the print base material 50 so as to laminate the foil thereon. In addition, the laminated foil manufacturing apparatus 100 includes a liquid fixing unit 30 and a transportation unit 40. The liquid fixing unit 30 performs fixing processing of fixing the liquid adhered to the print base material 50. The transportation unit 40 transports the print base material 50.

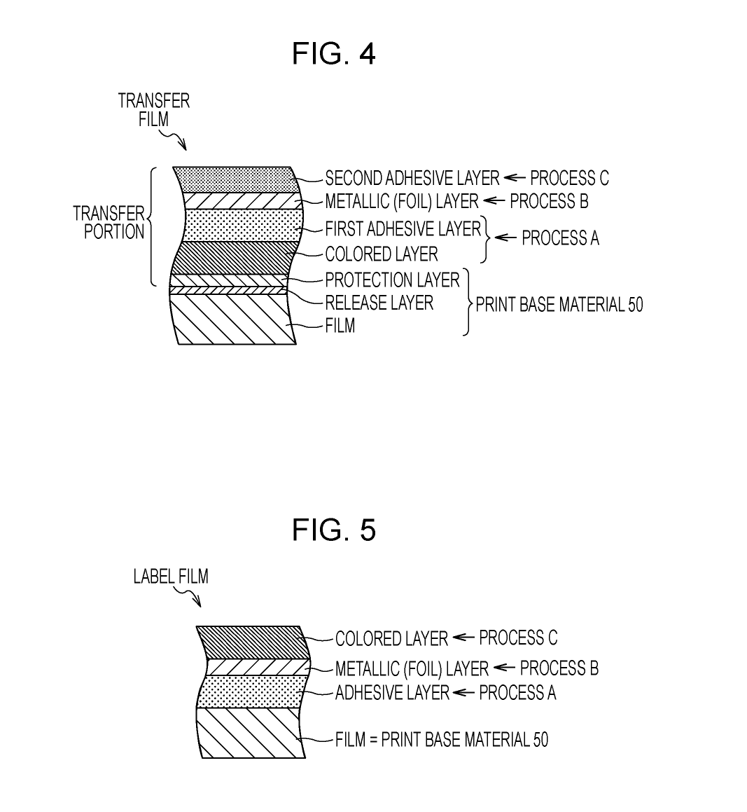

The laminated foil manufacturing apparatus 100 according to the embodiment manufactures a transfer film as an example of laminated foil. That is to say, the laminated foil manufacturing apparatus 100 forms an reverse image on the print base material 50 and laminates aluminum foil as an example onto the formed inverse image so as to form a decorated transfer film. It is to be noted that a long film made of a resin (for example, made of polyester) is used for the print base material 50 and a release layer and a protection layer are previously formed on the film surface side thereof on which an image is formed (see, FIG. 4).

The print base material 50 is transported by the transportation unit 40 with either of intermittent movement or continuous movement. To be more specific, the print base material 50 is transported after a feeding-out roll 41 wound in a roll form rotates in a feeding-out direction (dashed line arrow in FIG. 1) and the print base material 50 is fed out from the feeding-out roll 41 until the print base material 50 is wound up by a winding-up roll 48. Hereinafter, configurations of units including the transportation unit 40 are described.

The transportation unit 40 has a transportation mechanism which moves the print base material 50 among the liquid adhering unit 11, the foil laminating unit 20, and the liquid fixing unit 30. To be more specific, the transportation unit 40 includes a transportation roller 44 and intermediate rollers 45, 46. The transportation roller 44 is constituted by a driving roller 42 and a driven roller 43. The driving roller 42 and the driven roller 43 nip the print base material 50 from both sides of the front surface side and the rear surface side and transport it. The rear surface side of the print base material 50 is wound around the intermediate rollers 45, 46 to rotate. The driving roller 42 continuously rotates (solid line arrow in FIG. 1) or intermittently rotates (dashed line arrow in FIG. 1) with a driving force of a driving source (motor) (not illustrated) so that the transportation roller 44 and the intermediate rollers 45, 46 rotate in the same manner. Then, the rollers 44, 45, 46 rotate to move the print base material 50 continuously or intermittently so as to transport the print base material 50 from the feeding-out roll 41 to the winding-up roll 48. It is to be noted that rotations of the feeding-out roll 41 and the winding-up roll 48 are controlled by driving sources (not illustrated) so as not to hinder the movement of the print base material 50 when the print base material 50 is transported with the intermittent movement or the continuous movement.

Further, in the embodiment, the driving roller 42 of the transportation roller 44 and the intermediate roller 45 are arranged at the substantially same height positions while sandwiching the liquid adhering unit 11 from both of the right and left sides. The driving roller 42 of the transportation roller 44 and the intermediate roller 45 are configured to transport the print base material 50 in the substantially horizontal direction on the liquid adhering unit 11. Further, the intermediate roller 46 is arranged just under the intermediate roller 45 such that the foil laminating unit 20 is located between the intermediate roller 45 and the intermediate roller 46 in the up-down direction. With this configuration, the print base material 50 is transported with the foil laminating unit 20 in the up-down direction. Further, the liquid fixing unit 30 is arranged at a position between the intermediate roller 46 and the winding-up roll 48 so as to transport the print base material 50 in the substantially horizontal direction through the liquid fixing unit 30.

Accordingly, in the embodiment, the liquid adhering unit 11, the foil laminating unit 20, and the liquid fixing unit 30 are arranged in this order from the upstream side to the downstream side along the transportation direction of the print base material 50 which is transported from the feeding-out roll 41 to the winding-up roll 48.

After the print base material 50 has been fed out from the feeding-out roll 41, the liquid adhering unit 11 makes liquid adhere to the print base material 50 which is transported by the transportation unit 40 with the intermittent movement in the transportation direction (hereinafter, referred to as “intermittent transportation direction”) Hk (dashed line arrow in FIG. 1) so as to form an image thereon.

That is to say, the liquid adhering unit 11 includes the carriage 12 and a liquid ejecting head 14. A guide shaft 13 along the front-rear direction, which is bridged on the laminated foil manufacturing apparatus 100, is inserted through the carriage 12. The carriage 12 reciprocates in the scanning direction (front-rear direction) along the guide shaft 13. The liquid ejecting head 14 is attached to a lower surface of the carriage 12. Further, an ink cartridge 15 and an adhesive liquid cartridge 16 are mounted at the upper side of the carriage 12. The ink cartridge 15 and the adhesive liquid cartridge 16 accommodate ink and adhesive liquid as liquids, respectively. The ink and the adhesive liquid are supplied to the liquid ejecting head 14 through supply flow paths (not illustrated) provided on the carriage 12. The supplied ink and adhesive liquid are pressurized by pressure generation units (not illustrated) so as to be ejected onto the print base material 50 as ink droplets E1 and adhesive liquid droplets E2, respectively. Thus, the liquid adhering unit 11 is configured to function as an ink jet printer with serial scanning. The liquid adhering unit 11 ejects at least one of ink and adhesive liquid so as to form an image on the print base material 50.

In the embodiment, the ink droplets E1 are ejected at the upstream side and the adhesive liquid droplets E2 are ejected at the downstream side in the intermittent transportation direction Hk (here, right direction). That is to say, the adhesive liquid can be adhered onto the ink adhered to the print base material 50.

On the other hand, a holding portion 18 as a lamination target medium holding portion is provided at a position opposed to the liquid ejecting head 14. The holding portion 18 has a holding surface 18a as a lamination target medium holding surface, which holds the print base material 50 as a lamination target medium from the lower side, on an upper surface thereof. The holding surface 18a is formed so as to keep a state where the print base material 50 to be transported is distanced from the liquid ejecting head 14 by an appropriate distance when the ink droplets E1 and the adhesive liquid droplets E2 are ejected from the liquid ejecting head 14. Further, a drying unit 19 which evaporates at least a part of liquid components of the ink and the adhesive liquid is provided on the holding portion 18 such that the ink droplets E1 and the adhesive liquid droplets E2 ejected onto the print base material 50 do not flow after adhered to the print base material 50.

As the drying unit 19, a heating unit which is heated with heat conduction is employed in the embodiment. As an example, a nichrome wire can be used as the drying unit 19. Further, the drying unit 19 heats the entire region of the holding surface 18a and is arranged at a constant distance from the holding surface 18a, for example. With this, the liquid components of the ink and the adhesive liquid are uniformly evaporated by heating the print base material 50 from the lower side.

The foil laminating unit 20 is configured to transfer and laminate foil onto the print base material 50. That is to say, the foil laminating unit 20 includes a pair of rotary rollers 21, 22, a feeding-out roll 23, and a winding-up roll 24. The pair of rotary rollers 21, 22 rotate while nipping the print base material 50 and a foil transfer sheet 26 in a state of pressurizing them in an overlapping direction. The feeding-out roll 23 supplies the foil transfer sheet 26 to between the rotary roller 21 and the rotary roller 22. The winding-up roll 24 collects the foil transfer sheet 26 from which the foil has been transferred. It is to be noted that as the foil transfer sheet 26, a sheet obtained by forming an aluminum foil 25 on one surface of a base film by vapor deposition or the like is used, for example.

Further, in the embodiment, when the print base material 50 is intermittently moved through the foil laminating unit 20, the print base material 50 is moved and transported from the upper side to the lower side in the vertical direction in a state of being stretched as indicated by a two-dot chain line denoted with a reference numeral 50a in FIG. 1. Further, each of the pair of rotary rollers 21, 22 is located at a position distanced from the print base material 50(50a) in a moving state where the print base material 50 is intermittently moved. On the other hand, when the print base material 50 is continuously moved, the print base material 50 is moved and transported from the lower side at which the intermediate roller 46 is located to the upper side at which the intermediate roller 45 is located. When the print base material 50 is continuously moved to be transported, the rotary roller 21 moves to a right-side position as indicated by a solid line from a left-side position as indicated by the two-dot chain line denoted with the reference numeral 50a in FIG. 1. Then, the rotary roller 21 nips the print base material 50 with the rotary roller 22 while deflecting the print base material 50 to the right direction.

As illustrated in FIG. 1, the print base material 50 is displaced so as to be inclined with respect to the vertical direction with the deflection. The transportation direction (hereinafter, referred to as “continuous transportation direction”) Hr (indicated by a solid line arrow in FIG. 1) in which the print base material 50 (reference numeral 50b in FIG. 1) after displaced is transported with the continuous movement is kept to be in a state of intersecting the continuous transportation direction Hr of the print base material 50 (reference numeral 50c in FIG. 1) which moves on the holding surface 18a of the holding portion 18 in the horizontal direction.

Further, the rotary roller 22 of the pair of rotary rollers 21, 22 serves as a heating roller which heats the nipped print base material 50 through the foil transfer sheet 26. The foil 25 of the foil transfer sheet 26 which is supplied from the feeding-out roll 23 is pressed against an adhesive layer which exhibits adhesiveness by being heated by the rotary roller 22 so that a foil 25a is transferred onto the adhesive layer. Then, the foil transfer sheet 26 on which a foil 25b which has not been transferred is left is wound up by the winding-up roll 24 so as to be collected.

The liquid fixing unit 30 evaporates at least a part of remaining liquid components of the ink and the adhesive liquid of which part of liquid components have been evaporated by the drying unit 19 of the liquid adhering unit 11 so as to fix the ink and the adhesive liquid. That is to say, in the embodiment, the liquid fixing unit 30 includes a hot-air heater 32 in a casing 31. The hot-air heater 32 heats the print base material 50 which moves in the intermittent transportation direction Hk (left direction in FIG. 1) in the casing 31 with hot air. Then, the liquid fixing unit 30 performs fixing processing of evaporating and drying liquid components with hot air so as to fix the ink and the adhesive liquid to the print base material 50. It is needless to say that the liquid fixing unit 30 may include a UV irradiator in the casing 31 when the ink or the adhesive liquid is made of an ultraviolet curable material.

Further, in the embodiment, the liquid fixing unit 30 is arranged at a lower side of the liquid adhering unit 11. That is to say, accuracy of landing positions of the ink droplets E1 or the adhesive liquid droplets E2 which are ejected from the liquid ejecting head 14 onto the print base material 50 is not influenced by the hot air generated by the hot-air heater 32.

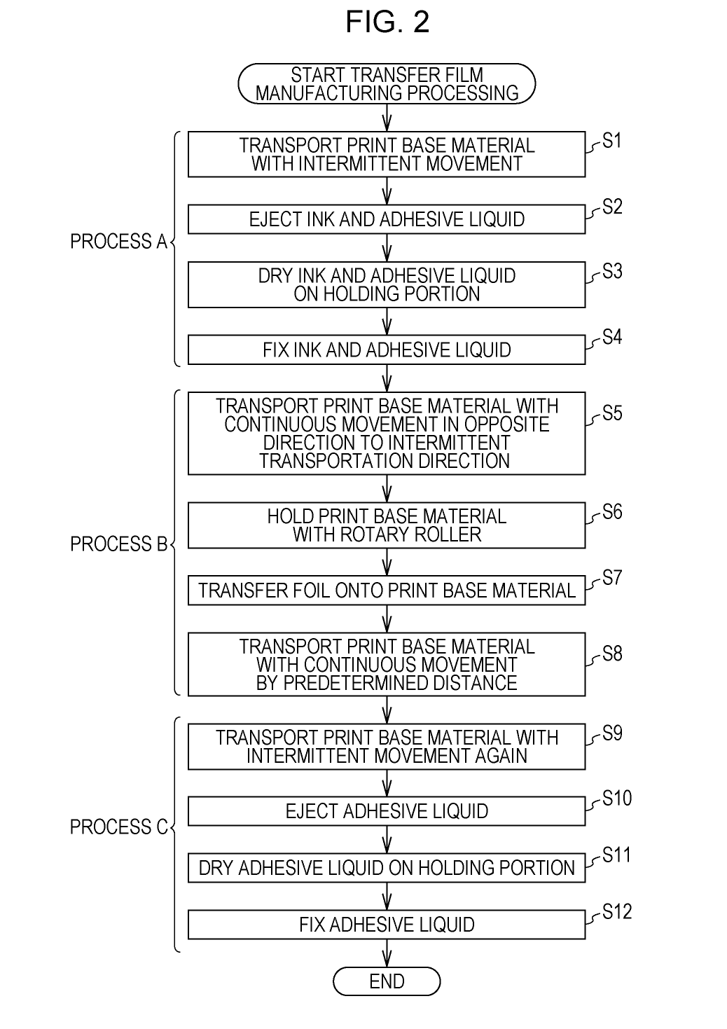

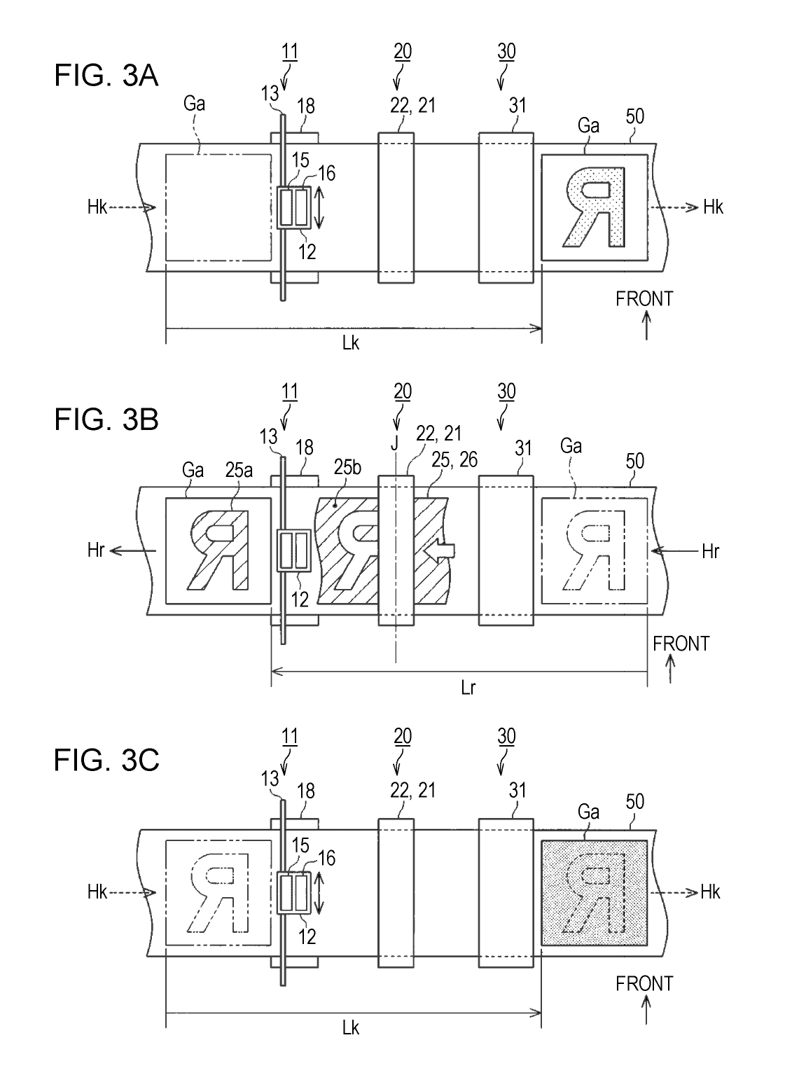

Next, actions on the laminated foil manufacturing apparatus 100 in which the units are configured as described above, that is, processes of manufacturing processing of a transfer film on which a transfer image with foil transferred has been formed, are described in accordance with a flowchart in FIG. 2 with reference to FIGS. 3A, 3B, and 3C. FIGS. 3A, 3B, and 3C illustrate the units included in the laminated foil manufacturing apparatus 100 in a state of being developed along a direction (for example, intermittent transportation direction Hk) in which the print base material 50 is transported. It is to be noted that this manufacturing processing is performed when a controller (not illustrated in FIG. 1) included in the laminated foil manufacturing apparatus 100 operates the liquid adhering unit 11, the foil laminating unit 20, the liquid fixing unit 30, and the transportation unit 40.

As illustrated in FIG. 2, if a manufacturing process of a transfer film is started, the print base material 50 is transported with intermittent movement, at first (step S1). That is to say, the transportation unit 40 drives the driving roller 42 of the transportation roller 44 such that rotation and stop are repeated in the clockwise direction (see, dashed line arrow in FIG. 1) when seen from the rear side. With this, the print base material 50 is transported with the intermittent movement along the holding surface 18a of the holding portion 18 on the liquid adhering unit 11 in the intermittent transportation direction Hk (right direction in FIG. 1).

Next, ink and adhesive liquid are ejected (step S2). That is to say, the liquid adhering unit 11 performs serial scanning of moving the carriage 12 in the scanning direction on the print base material 50 which is intermittently moved so that the ink droplets E1 and the adhesive liquid droplets E2 are ejected from the liquid ejecting head 14. Note that the liquid adhering unit 11 performs the serial scanning in a state where the print base material 50 is stopped. Accordingly, the ink and the adhesive liquid are adhered to a base material surface of the print base material 50 by the liquid adhering unit 11 so that a transfer image Ga (see, FIG. 3A) is formed.

Then, the ink and the adhesive liquid are dried on the holding portion 18 (step S3). The ink and the adhesive liquid which have been adhered to the print base material 50 are heated by the drying unit 19 on the holding portion 18. With this, at least a part of the liquid components (solvents) thereof are dried such that the ink and the adhesive liquid adhered to the print base material 50 do not flow. Note that a heating temperature on the holding portion 18 is approximately 40° to 60° C.

Subsequently, the ink and the adhesive liquid are fixed (step S4). The print base material 50 is continuously transported with the intermittent movement by the transportation unit 40 until the transfer image Ga reaches the liquid fixing unit 30. Then, the hot-air heater 32 feeds hot air to the print base material 50 on which the transfer image Ga is formed and which is moved from the upstream side to the downstream side in the intermittent transportation direction Hk in the casing 31 on the liquid fixing unit 30. With this, liquid components of the ink and the adhesive liquid adhered to the transfer image Ga are evaporated and dried so that the ink and the adhesive liquid are fixed to the print base material 50. Note that a temperature of the hot air is approximately 70° to 80° C.

Operations of the laminated foil manufacturing apparatus 100 in a process A from the above steps S1 to S4 are described supplementarily with reference to FIG. 3A. As illustrated in FIG. 3A, at least one image formation region on which the transfer image Ga for transfer is formed is set on the print base material 50. Further, in the process A, the ink and the adhesive liquid are adhered to the set (one in the embodiment) image formation region by the liquid adhering unit 11 on the movement of the print base material 50 in the intermittent transportation direction Hk so that the transfer image Ga is formed. Thereafter, the formed transfer image Ga is moved to the liquid fixing unit 30 along the intermittent transportation direction Hk and the ink and the adhesive liquid on the transfer image Ga are fixed by the liquid fixing unit 30 so as to be formed as a colored layer and an adhesive layer, respectively.

Accordingly, in the process A, the transportation unit 40 moves the print base material 50 by a distance Lk along the intermittent transportation direction Hk so as to move the transfer image Ga to the downstream side of the casing 31 of the liquid fixing unit 30. At this time, both of the rotary rollers 21, 22 are distanced from the print base material 50 which is transported with the intermittent movement.

In the embodiment, an alphabet “R” is set as an image portion to be decorated by laminating foil onto the transfer image Ga. The adhesive layer is formed on a region portion of a reversal character of the alphabet “R” on the transfer image Ga.

Returning to FIG. 2, next, the print base material 50 is transported with the continuous movement in an opposite direction to the intermittent transportation direction Hk (step S5). That is to say, the transportation unit 40 drives the driving roller 42 of the transportation roller 44 so as to continuously rotate in the counterclockwise direction (see, solid line arrow in FIG. 1) when seen from the rear side without stopping. With this, the print base material 50 is transported with the continuous movement in the opposite direction to the transportation direction with the intermittent movement.

Next, the print base material 50 is nipped between the rotary roller 21 and the rotary roller 22 (step S6). That is to say, the foil laminating unit 20 moves the rotary roller 21 to the right direction as the direction of being closer to the rotary roller 22 so that the rotary roller 21 and the rotary roller 22 nip the print base material 50 together with the foil transfer sheet 26. Then, the foil 25 is transferred onto the print base material 50 from the foil transfer sheet 26 (step S7). That is to say, on the print base material 50 which is transported with the continuous movement, the transfer image Ga on which the colored layer and the adhesive layer have been formed are heated and the foil 25 is pressed to the transfer image Ga. Accordingly, the foil is pressed in a state where the adhesive layer formed on the transfer image Ga exhibits adhesiveness by being heated so that the foil is transferred onto the entire adhesive layer.

Subsequently, the print base material 50 is transported with the continuous movement by a predetermined distance (step S8). In the embodiment, the transportation unit 40 transports the print base material 50 with the continuous movement by the predetermined distance in the continuous transportation direction Hr until the transfer image Ga onto which the foil has been transferred is located at the upstream side of the liquid adhering unit 11 in the intermittent transportation direction Hk.

Operations of the laminated foil manufacturing apparatus 100 in the process B from the above steps S5 to S8 are described supplementarily with reference to FIG. 3B. As illustrated in FIG. 3B, in the process B, the foil 25a of the foil 25 of the foil transfer sheet 26 is transferred onto the transfer image Ga with heat and pressure by the pair of rotary rollers 21, 22 on the foil laminating unit 20 during the movement of the print base material 50 in the continuous transportation direction Hr. As a result, a metallic layer is formed with the transferred foil 25a on a shape portion of the adhesive layer, that is, the region portion of the reversal character of the alphabet “R” in the region of the transfer image Ga.

Accordingly, the pair of rotary rollers 21, 22 are arranged such that directions of rotating shafts J thereof correspond to at least the width direction orthogonal to the continuous transportation direction Hr of the print base material 50. Therefore, the foil 25 is stably transferred onto the print base material 50 (transfer image Ga) so as not to be distorted.

Further, in the process B, the transportation unit 40 moves the print base material 50 by a predetermined distance Lr along the continuous transportation direction Hr. That is to say, the transportation unit 40 moves the print base material 50 to a position at which at least the adhesive liquid can be adhered to the transfer image Ga onto which the foil 25a has been transferred from the liquid adhering unit 11 when the print base material 50 is transported with the intermittent movement in the transportation direction opposite to the continuous transportation direction Hr, again.

Returning to FIG. 2, next, the print base material 50 is transported with the intermittent movement, again (step S9). That is to say, the transportation unit 40 drives the driving roller 42 such that rotation and stop are repeated in the clockwise direction (see, dashed line arrow in FIG. 1) when seen from the rear side, again. With this, the print base material 50 is transported with the intermittent movement.

Next, the adhesive liquid is ejected (step S10). That is to say, the liquid adhering unit 11 performs serial scanning of moving the carriage 12 in the scanning direction on the print base material 50 which is intermittently moved so that the adhesive liquid droplets E2 are ejected from the liquid ejecting head 14. Note that the liquid adhering unit 11 performs the serial scanning in a state where the print base material 50 is stopped. Accordingly, the adhesive liquid is adhered to the transfer image Ga of the print base material 50 by the liquid adhering unit 11.

Then, the adhesive liquid is dried on the holding portion 18 (step S11). In the same manner as step S2, the adhesive liquid which has been adhered to transfer image Ga is heated by the drying unit 19 on the holding portion 18. With this, at least a part of the liquid component (solvent) thereof is dried such that the adhered adhesive liquid does not flow.

Subsequently, the adhesive liquid is fixed (step S12). The print base material 50 is continuously transported with the intermittent movement by the transportation unit 40 until the transfer image Ga reaches the liquid fixing unit 30. Then, after the transfer image Ga has reached the liquid fixing unit 30, the hot-air heater 32 feeds hot air to the print base material 50 which is moved in the intermittent transportation direction Hk in the casing 31 on the liquid fixing unit 30. With this, the liquid component of the adhesive liquid adhered to the transfer image Ga is evaporated and dried so that the adhesive liquid is fixed to the print base material 50. With this process, a transfer film is completely obtained and the manufacturing process of the transfer film is finished.

Operations of the laminated foil manufacturing apparatus 100 in the process C from the above steps S9 to S12 are described supplementarily with reference to FIG. 3C. As illustrated in FIG. 3C, in the process C, the liquid adhering unit 11 makes the adhesive liquid adhere to the transfer image Ga onto which the foil has been transferred on the print base material 50 in a state where the print base material 50 is stopped during the movement of the print base material 50 in the intermittent transportation direction Hk. Thereafter, the transfer image Ga to which the adhesive liquid has been adhered is moved to the liquid fixing unit 30 along the intermittent transportation direction Hk. Further, with the movement within the casing 31, the adhesive liquid adhered to the transfer image Ga is fixed so that an adhesive layer is formed.

Accordingly, in the process C, the transportation unit 40 moves the print base material 50 by a predetermined distance Lk along the intermittent transportation direction Hk, again, so as to move the transfer image Ga to the downstream side of the casing 31 of the liquid fixing unit 30. It is to be noted that both of the rotary rollers 21, 22 are distanced from the print base material 50 which is transported with the intermittent movement in the same manner as the process A.

With the above-described processes A, B, and C, the transfer film having the adhesive layer, the metallic layer, and the colored layer as described above is formed on the print base material 50. That is to say, the process A and the process C are liquid adhering processes, and the process B is a foil laminating process. A layer structure along a cross-sectional direction of the transfer film formed with the processes A, B, and C is illustrated in FIG. 4.

As illustrated in FIG. 4, the transfer film which is manufactured by the laminated foil manufacturing apparatus 100 has a layer structure in which a colored layer, a first adhesive layer, a metallic (foil) layer, a second adhesive layer are laminated on a protection layer of the print base material 50 in this order from the lower side. On the print base material 50, a release layer and the protection layer are formed on a base film made of a resin so as to be laminated in this order from the lower side. As described above, the colored layer and the first adhesive layer are formed in the process A, the metallic layer is formed in the process B, and the second adhesive layer is formed in the process C. It is needless to say that overlapped layers from the protection layer to the second adhesive layer correspond to a transfer portion.

In the embodiment, a case in which one transfer image Ga is formed on the print base material 50 has been described. However, a plurality of transfer images Ga are formed along the intermittent transportation direction Hk (or continuous transportation direction Hr) of the print base material 50 actually. Accordingly, for example, the liquid adhering unit 11 ejects the ink and the adhesive liquid onto a plurality of image formation regions set to the print base material 50 and makes them adhere thereto so as to form the plurality of transfer images Ga in the process A. Therefore, in the process A, the process B, and the process C, movement distances Lk, Lr when the print base material 50 is intermittently moved and continuously moved, respectively, are set in accordance with the number of formed transfer images Ga.

With the above-described embodiment, the following effects can be obtained.

1. Ink and adhesive liquid are ejected onto the print base material 50 in a state where transportation of the print base material 50 with the intermittent movement is stopped, thereby forming (printing) an image on the print base material 50 with ink jet recording of serial scanning. Accordingly, the laminated foil manufacturing apparatus 100 can be suppressed from being increased in size. On the other hand, the foil 25 is laminated onto the print base material 50 which is transported with the continuous movement so that the foil 25(25a) can be laminated onto the print base material 50 stably.

2. Transportation with the intermittent movement and transportation with the continuous movement are not mixed in one transportation direction. Therefore, a transportation buffering mechanism which absorbs a difference in a transportation amount between the transportation with the intermittent movement and the transportation with the continuous movement is not required to be provided. Accordingly, the laminated foil manufacturing apparatus 100 can be suppressed from being increased in size.

3. The print base material 50 onto which foil has been laminated is transported with the intermittent movement, again. Therefore, the liquid adhering unit 11 can perform the ink jet recording of the serial scanning on the print base material 50 so as to make the ink or the adhesive liquid adhere thereto, again. Accordingly, laminated foil such as a transfer film can be manufactured efficiently. For example, overlapping recording can be performed.

4. After the liquid fixing unit 30 has performed first fixing processing of fixing the ink and the adhesive liquid adhered to the print base material 50 when the print base material 50 is transported with the intermittent movement, second fixing processing of fixing the adhered ink and the adhesive liquid can be performed on the print base material 50 which is transported with the continuous movement in the opposite direction to a direction in which the print base material 50 is transported with the intermittent movement. Accordingly, the ink and the adhesive liquid can be fixed stably.

Further, the temperature of the print base material 50 at which the foil laminating processing is performed by the foil laminating unit 20 can be adjusted when the print base material 50 is transported with the continuous movement. In addition, the foil laminating unit 20 is provided between the liquid fixing unit 30 and the liquid adhering unit 11. Therefore, affect of heating the liquid fixing unit 30 (hot air) can be suppressed from acting on the liquid adhering unit 11, for example.

The liquid adhering unit 11 and the liquid fixing unit 30 are arranged in the up-down direction (vertical direction). Therefore, the foil laminating unit 20 can be arranged at an offset position in the horizontal direction (right direction) so as not to overlap with these units. Accordingly, the laminated foil manufacturing apparatus 100 can be suppressed from being thick in the vertical direction.

5. The print base material 50 is transported with the continuous movement by the transportation roller 44 provided at the downstream side with respect to the liquid adhering unit 11 in the transportation direction thereof. Therefore, the foil laminating processing can be performed on the print base material 50 while continuously rotating the pair of rotary rollers which nip the print base material 50 therebetween. Accordingly, in the foil laminating processing, a preferred configuration as the transportation unit 40 which transports the print base material 50 with the continuous movement in the opposite direction to the direction in which the print base material 50 is transported with the intermittent movement can be obtained.

6. Even if the print base material 50 is displaced with displacement of the rotary roller 21 in the foil laminating processing, an influence by the displacement of the print base material 50 in the normal direction of the holding surface 18a can be suppressed in the holding surface 18a of the holding portion 18. Accordingly, the print base material 50 which is continuously transported and the liquid adhering unit 11 (liquid ejecting head 14) are suppressed from making into contact with each other.

It is to be noted that the above embodiment may be changed to the following other embodiments.

In the above embodiment, a label film which does not require transferring may be manufactured in the laminated foil manufacturing apparatus 100. A layer structure of a label film along the cross-sectional direction which is formed in the variation is illustrated in FIG. 5.

As illustrated in FIG. 5, the label film which is manufactured by the laminated foil manufacturing apparatus 100 has a layer structure in which a base film made of a resin is used as the print base material 50 and an adhesive layer, a metallic (foil) layer, and a colored layer are formed on one film surface of the print base material 50 so as to be laminated in this order from the lower side. Further, in the description of the above embodiment, adhesive liquid is adhered so that an adhesive layer is formed in the process A, and ink is adhered so that a colored layer is formed in the process C. The process B in which the metallic (foil) layer is formed is the same as that in the above embodiment.

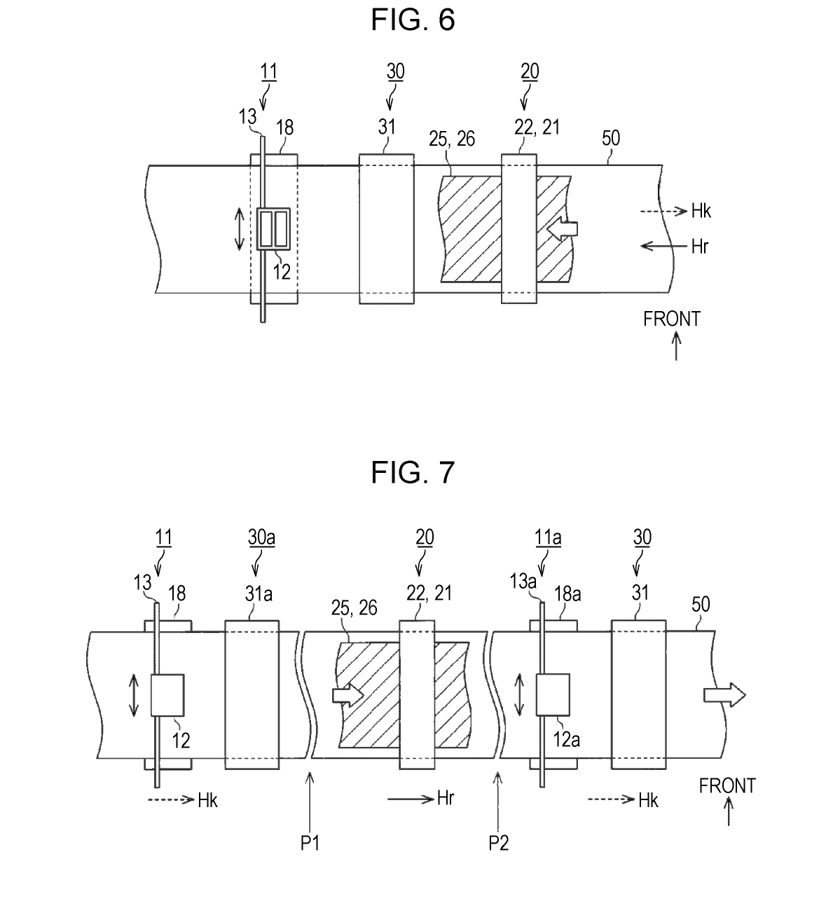

In the above embodiment, the foil laminating unit 20 may not be necessarily arranged between the liquid adhering unit 11 and the liquid fixing unit 30 along the intermittent transportation direction Hk (or continuous transportation direction Hr) of the print base material 50. In the variation, the arrangement as an example thereof is described with reference to FIG. 6. It is to be noted that in FIG. 6, the same reference numerals denote the same constituent elements as those in the above embodiment and description thereof is not repeated.

As illustrated in FIG. 6, in the variation, the foil laminating unit 20 is arranged at the downstream side with respect to the fixing unit 30 in the intermittent transportation direction Hk. With this arrangement, the distance between the liquid adhering unit 11 and the liquid fixing unit 30 can be made shorter. Therefore, on the liquid adhering unit 11, even if the adhered ink and adhesive liquid are not sufficiently dried, a possibility that the ink and the adhesive liquid can be fixed before flowing on the print base material 50 is increased.

In the above embodiment, when the print base material 50 is transported in both manners of the intermittent movement and the continuous movement, the print base material 50 may be always moved in one direction without being moved in the opposite direction. In the variation, the configuration as an example thereof is described with reference to FIG. 7. It is to be noted that in FIG. 7, the same reference numerals denote the same constituent elements as those in the above embodiment and description thereof is not repeated.

As illustrated in FIG. 7, the variation is different from the above embodiment in that a liquid fixing unit 30a is further provided between the liquid adhering unit 11 and the foil laminating unit 20 in the configuration as illustrated in FIG. 3A, and a liquid adhering unit 11a is further provided between the foil laminating unit 20 and the liquid fixing unit 30. Further, the intermittent transportation direction Hk and the continuous transportation direction Hr are the same direction as indicated by outline arrows in FIG. 7 and the print base material 50 is transported with continuous movement on the foil laminating unit 20. On the other hand, the print base material 50 is transported with intermittent movement on the liquid adhering units 11, 11a and the liquid fixing units 30, 30a other than the foil laminating unit 20, and ink and adhesive liquid are ejected with an ink jet system of serial scanning so as to form a transfer image.

Accordingly, in the variation, the same effect as the effect 1 in the above embodiment can be obtained. In the variation, transportation buffering mechanisms each of which absorbs a difference in a transportation amount between the transportation with the intermittent movement and the transportation with the continuous movement are provided at a position P1 at the upstream side and a position P2 at the downstream side with respect to the foil laminating unit 20 in the continuous transportation direction Hr of the print base material 50.

In the above embodiment, for example, when ink and adhesive liquid are fixed on the holding portion 18, when ink and adhesive liquid are dried and fixed with natural drying on the movement, or the like, the liquid fixing unit 30 may not be necessarily provided.

In the above embodiment, the transportation unit 40 may not necessarily transport the print base material 50 onto which the foil 25 has been laminated by the foil laminating unit 20 to the upstream side in the transportation direction of the print base material 50 with the continuous movement when the print base material 50 is transported by a distance Lr so as to be transported to the liquid adhering unit 11 with the intermittent movement. For example, when adhesive liquid can be adhered to the transfer image Ga on the print base material 50 which is transported with the continuous movement, such configuration can be employed. To be more specific, when a manufacturing process of laminating foil to be manufactured is finished upon lamination of foil, when a linear adhesive layer along the continuous transportation direction Hr as an example is formed, or the like, such configuration can be employed.

In the above embodiment, the transportation rollers 44 which nip and transport the print base material 50 may not be necessarily provided. For example, the driving roller 42 may be a knurled roller and configured as a transportation roller having no driven roller. Alternatively, the print base material 50 may be transported by rotationally driving the feeding-out roll 41 and the winding-up roll 48 instead of the transportation roller 44.

In the above embodiment, the foil laminating unit 20 may be configured such that not the rotary roller 21 but the rotary roller 22 is displaced. In this case, the feeding-out roll 23 and the winding-up roll 24 may be displaced together with the rotary roller 22.

In the above embodiment, the movement direction of the print base material 50(50b) which moves through the foil laminating unit 20 and the movement direction of the print base material 50(50c) which moves on the holding surface 18a of the holding portion 18 may not necessarily intersect with each other. For example when the intermediate roller 45 is constituted by a pair of nip rollers which nip the print base material 50 therebetween, the movement directions thereof may be parallel (horizontal) with each other.

In the above embodiment, one ink cartridge 15 which accommodates ink is mounted on the carriage 12. However, a plurality of ink cartridges which accommodate inks of a plurality of types, respectively, may be provided. Further, a so-called off-carriage system in which the ink cartridge is not mounted on the carriage 12 may be employed.

In the above embodiment, a plurality of adhesive liquid cartridges which accommodate adhesive liquids of a plurality of types, respectively, may be provided. In this case, adhesive liquid to be ejected in the process A and adhesive liquid to be ejected in the process C may be different from each other. Further, a so-called off-carriage system in which the adhesive liquid cartridge is not mounted on the carriage 12 may be employed.

In the above embodiment, in the manufacturing processing in the process C, ink may be ejected instead of the adhesive liquid. It is needless to say that both of ink and adhesive liquid may be ejected.

In the above embodiment, the liquid adhering unit 11 is embodied as an ink jet printer. However, the liquid adhering unit 11 may be embodied as a liquid ejecting apparatus which ejects and discharges liquid other than ink. Various types of liquid ejecting apparatuses including liquid ejecting heads or the like which discharge a trace amount of liquid droplets can be employed. Note that the terminology “liquid droplets” represents a state of liquid which is discharged from the above liquid ejecting apparatus. For example, a granule form, a teardrop form, and a form that pulls tails in a string-like form therebehind are included as the liquid droplets. The terminology “liquid” here represents materials which can be ejected by the liquid ejecting apparatus. For example, any materials are included as long as the materials are in a liquid phase. For example, materials in a liquid state having high viscosity or low viscosity or a fluid state such as a sol, gel water, other inorganic solvents, an organic solvent, a solution, a liquid resin or a liquid metal (molten metal) can be included as the liquid. Further, the liquid is not limited to a liquid as one state of a material but includes a solution, a dispersion or a mixture of particles of a functional material made of a solid material such as pigment or metal particles. The terminology “ink” here encompasses various liquid compositions such as common aqueous ink and oil ink, gel ink and hot melt ink, and so on.

The entire disclosure of Japanese Patent Application No. 2011-142605, filed Jun. 28, 2011 is expressly incorporated by reference herein.

What is claimed is:

1. A laminated foil manufacturing apparatus comprising:
a transportation unit that transports a lamination target medium onto which foil is to be laminated with intermittent movement and continuous movement;
a liquid adhering unit that performs adhering processing of making liquid adhere to the lamination target medium which is transported with the intermittent movement by the transportation unit; and
a foil laminating unit that is arranged at a downstream side with respect to a position of the liquid adhering unit in a transportation direction of the lamination target medium which is transported with the intermittent movement, and performs foil laminating processing of laminating the foil onto a surface to which the liquid has been adhered on the lamination target medium which is transported with the continuous movement by the transportation unit after the adhering processing has been performed.

2. The laminated foil manufacturing apparatus according to claim 1,
wherein the transportation unit transports the lamination target medium with the continuous movement in an opposite direction to a direction in which the lamination target medium is transported with the intermittent movement.

3. The laminated foil manufacturing apparatus according to claim 2,
wherein the transportation unit transports the lamination target medium onto which the foil has been laminated by the foil laminating unit with the continuous movement to an upstream side with respect to a position of the liquid adhering unit in a transportation direction of the lamination target medium which is transported with the intermittent movement.

4. The laminated foil manufacturing apparatus according to claim 2, further including a liquid fixing unit that is arranged at a downstream side with respect to a position of the foil laminating unit in a transportation direction of the lamination target medium which is transported with the intermittent movement, and performs fixing processing of fixing the liquid adhered by the liquid adhering unit to the lamination target medium.

5. The laminated foil manufacturing apparatus according to claim 2,
wherein the transportation unit includes a pair of transportation rollers that nip and transport the lamination target medium at a downstream side with respect to the liquid adhering unit in a transportation direction of the lamination target medium when the lamination target medium is transported with the continuous movement, and
the foil laminating unit includes a pair of rotary rollers that nip the lamination target medium and the foil and rotate about shafts extending in a width direction intersecting with a transportation direction of the lamination target medium which is transported with the continuous movement when the lamination target medium is transported with the continuous movement.

6. The laminated foil manufacturing apparatus according to claim 5, further including a lamination target medium holding portion having a lamination target medium holding surface which holds the lamination target medium which is transported while the adhering processing is performed by the liquid adhering unit,
wherein the pair of rotary rollers included by the foil laminating unit nip the lamination target medium which is transported with the continuous movement in a direction intersecting with the lamination target medium holding surface.

7. A laminated foil manufacturing method comprising:
liquid adhering in which a lamination target medium onto which a foil is to be laminated is transported with intermittent movement, and adhering processing that is liquid adhering is performed on the lamination target medium which is transported with the intermittent movement; and
foil laminating in which the lamination target medium which has been performed the adhering processing is transported with continuous movement and the foil is laminated on the surface on which the liquid has been adhered on the lamination target medium which is transported with continuous movement.
